(19) United States
(12) Patent Application Publication
(10) Pub. No.: US 2025/0244256 A1
(43) Pub. Date: Jul. 31, 2025

(54) INSPECTION APPARATUS AND METHOD FOR PRODUCING CAMERA MODULE

(71) Applicant: Sharp Sensing Technology Corporation, Tenri City (JP)

(72) Inventors: Takafumi TOYODA, Tenri City (JP); Masahiro NAKAMURA, Tenri City (JP); Kazuo TAMAKI, Tenri City (JP)

(21) Appl. No.: 18/976,533

(22) Filed: Dec. 11, 2024

(30) Foreign Application Priority Data
Jan. 26, 2024 (JP) 2024-010523

(51) Int. Cl. G01N 21/94

(52) U.S. Cl. CPC G01N 21/94

(57) ABSTRACT

An inspection apparatus comprises an attaching-detaching unit configured to attach and detach an optical member to be used for a camera module, a light source configured to emit light to be transmitted through the optical member, and an imaging element configured to obtain an image formed of the light transmitted through the optical member, the image including a shadow of a foreign object.

### CROSS-REFERENCE TO RELATED APPLICATION

The present application claims priority from Japanese Application JP2024-010523, the content of which is hereby incorporated by reference into this application.

### BACKGROUND

### 1. Field

The present disclosure relates to an inspection apparatus and a method for producing a camera module.

### BACKGROUND ART

Japanese Patent Application Publication No. 2011-179898 discloses a lens defect inspection apparatus. The lens defect inspection apparatus stores imaging data of a lens before air injection. Then, the lens defect inspection apparatus injects the air to blow off a foreign object adhering to either a front surface or a rear surface of the lens. After that, the lens defect inspection apparatus stores imaging data of the lens after air injection. Furthermore, if a defect is detected from the imaging data before the air injection whereas no foreign object is detected from the imaging data after the air injection, the lens defect inspection apparatus determines that the defect is a foreign object adhering to the lens and that the foreign object has been removed with the air. The lens is captured in a state where the foreign object adhering to either the front surface or the rear surface of the lens appears clear with a great degree of contrast (see paragraphs [0014], [0028], [0030], [0031], and [0032]).

### SUMMARY

In a camera module, light is transmitted through an optical member such as a lens or an infrared cut filter. The transmitted light forms an image on an imaging element, and the formed image is obtained by the imaging element. Hence, a foreign object adhering to the optical member is not focused. Thus, when inspection is conducted to find out whether foreign objects adhere to the optical member, and the foreign objects are focused, the inspection could detect a foreign object causing no problems to the camera module.

An aspect of the present disclosure is devised in view of the above problem. An aspect of the present disclosure sets out to provide an inspection apparatus that can, for example, inspect appropriately whether a foreign object adheres to an optical member to be used for a camera module. The aspect of the present disclosure also sets out to provide a method for producing the camera module.

An inspection apparatus according to a first aspect of the present disclosure includes: an attaching-detaching unit that attaches and detaches an optical member to be used for a camera module; a light source that emits light to be transmitted through the optical member; and an imaging element that obtains an image formed of the light transmitted through the optical member. The image includes a shadow of a foreign object.

A method for producing a camera module according to a second aspect of the present disclosure includes steps of: a) inspecting the optical member using the inspection apparatus according to claim 1, while optical alignment of a first plurality of optical members including the optical member in the inspection apparatus is set equivalent to optical alignment of a second plurality of optical members including the optical member in the camera module; and b) assembling the camera module after step a).

A method for producing a camera module according to a third aspect of the present disclosure includes: a) inspecting the optical member with the inspection apparatus according to claim 1; b) assembling the camera module after step a); and c) inspecting the camera module after step b) using a camera module inspection apparatus, while an inspection condition of the camera module inspection apparatus is set equivalent to an inspection condition of the inspection apparatus.

### BRIEF DESCRIPTION OF THE DRAWINGS

FIG. 1 is a diagram schematically illustrating an inspection apparatus of a first embodiment and an infrared cut filter (IRCF) to be inspected with the inspection apparatus;

FIG. 2 is a perspective view schematically illustrating a support table and a placing table included in the inspection apparatus of the first embodiment, and the IRCF to be inspected with the inspection apparatus;

FIG. 3 is a flowchart showing a sequence of inspecting the IRCF with the inspection apparatus of the first embodiment;

FIG. 4 is a diagram showing how a processing unit included in the inspection apparatus of the first embodiment determines whether a foreign object adhering to the IRCF is an adhering foreign object;

FIG. 5 is a flowchart showing a sequence of producing a camera module including the IRCF inspected with the inspection apparatus of the first embodiment;

FIG. 6 is a cross-sectional view schematically illustrating optical alignment of a lens, an IRCF, and an imaging element included in the camera module, the IRCF being inspected with the inspection apparatus of the first embodiment;

FIG. 7 is a diagram schematically illustrating an inspection apparatus of a second embodiment and an IRCF to be inspected with the inspection apparatus;

FIG. 8 is a diagram schematically illustrating an inspection apparatus of a third embodiment and a lens to be inspected with the inspection apparatus;

FIG. 9 is a perspective view schematically illustrating a lens socket, a rotary stage, and a rotary stage placing table included in the inspection apparatus of the third embodiment, and a lens to be inspected with the inspection apparatus;

FIG. 10 is a flowchart showing a sequence of inspecting the lens with the inspection apparatus of the third embodiment;

FIG. 11 is a flowchart showing a sequence of producing a camera module including the lens inspected with the inspection apparatus of the third embodiment;

FIG. 12 is a cross-sectional view schematically illustrating optical alignment of a lens, an IRCF, and an imaging element included in a camera module, the lens being inspected with the inspection apparatus of the third embodiment;

FIG. 13 is a diagram schematically illustrating an inspection apparatus according to a fourth embodiment and an IRCF to be inspected with the inspection apparatus;

FIG. 14 is a flowchart showing a sequence of inspecting the IRCF with the inspection apparatus of the fourth embodiment;

FIG. 15 is a diagram showing how a processing unit included in the inspection apparatus of the fourth embodiment determines whether a foreign object adhering to an IRCF lens is an adhering foreign object;

FIG. 16 is a diagram schematically illustrating an inspection apparatus of a fifth embodiment and an IRCF to be inspected with the inspection apparatus;

FIG. 17 is a cross-sectional view schematically illustrating a glass cover included in the inspection apparatus of the fifth embodiment;

FIG. 18 is a diagram schematically illustrating an inspection apparatus of a sixth embodiment and an IRCF to be inspected with the inspection apparatus; and

FIG. 19 is a flowchart showing a sequence of inspecting the IRCF with the inspection apparatus of the sixth embodiment.

### DESCRIPTION OF EMBODIMENTS

Embodiments of the present disclosure will be described below with reference to the drawings. Note that, throughout the drawings, like reference signs denote identical or similar constituent features. Such features will not be repeatedly elaborated upon.

### 1 First Embodiment

### 1.1 Inspection Apparatus

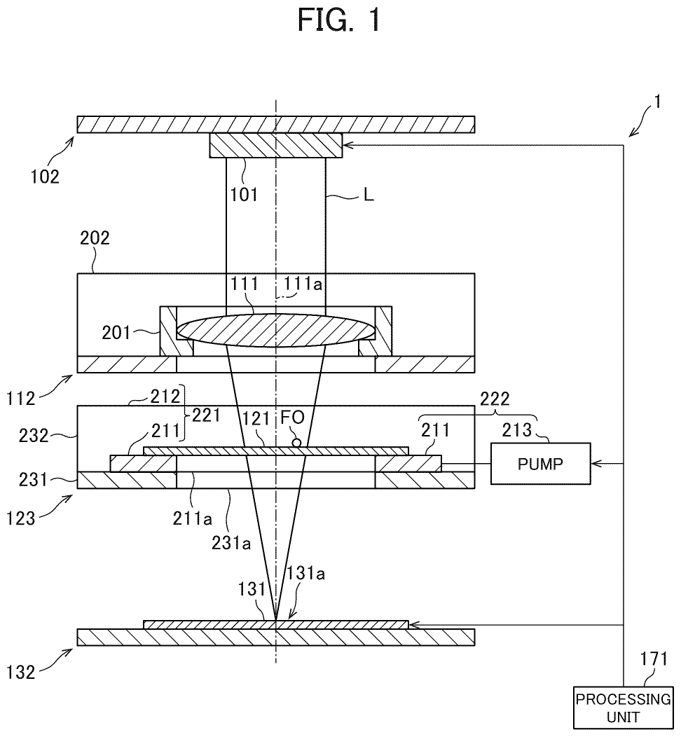

FIG. 1 is a diagram schematically illustrating an inspection apparatus of a first embodiment and an infrared cut filter (IRCF) to be inspected with the inspection apparatus.

An inspection apparatus 1 of the first embodiment illustrated in FIG. 1 is used for inspecting an IRCF 121. Inspecting the IRCF 121 also includes determining whether a foreign object FO adheres to the IRCF 121.

The IRCF 121 is an example of an optical member to be inspected with the inspection apparatus 1. An optical member other than the IRCF 121 may be inspected with the inspection apparatus 1. For example, a mirror, a prism, and a filter other than the IRCF may be inspected with the inspection apparatus 1.

As illustrated in FIG. 1, the inspection apparatus 1 includes: a light source 101; a light source fastening mechanism 102; a lens 111; a lens fastening mechanism 112; an IRCF displacing mechanism 123; an imaging element 131; an imaging element fastening mechanism 132; and a processing unit 171.

The light source 101, the lens 111, and the imaging element 131 are respectively fastened to the light source fastening mechanism 102, the lens fastening mechanism 112, and the imaging element fastening mechanism 132. The IRCF displacing mechanism 123 serves as an attaching-detaching unit that can attach and detach the IRCF 121. The IRCF 121 is attached to, and detached from, the IRCF displacing mechanism 123 by an operator or with an automated conveyer mechanism.

When the IRCF 121 is inspected with the inspection apparatus 1, the IRCF 121 is attached to the IRCF displacing mechanism 123. In a state where the IRCF 121 is attached to the IRCF displacing mechanism 123, the light source 101, the lens 111, the IRCF 121, and the imaging element 131 are aligned in the stated order along an optical axis 111a of the lens 111. The lens 111 and the IRCF 121 are disposed between the light source 101 and the imaging element 131.

The light source 101 emits light L. The light source 101 applies the emitted light L to the lens 111, the IRCF 121, and the imaging element 131. The light source 101 is, for example, a light-emitting diode, an incandescent lamp, a fluorescent lamp, or an electroluminescence element.

The lens 111 transmits the light L. The transmitted light L is condensed to form an image on an imaging surface 131a of the imaging element 131.

The IRCF 121 transmits the light L. The IRCF 121 filters out an infrared component from the light L to be transmitted.

The imaging element 131 photoelectrically converts the condensed light. Thus, the imaging element 131 obtains the formed image, and outputs image data corresponding to the obtained image. If the foreign object FO is found in an optical path of the light L, the obtained image includes a shadow of the foreign object FO. The foreign object FO is not focused. Hence, the shadow of the foreign object FO is a blurred defocused image. The imaging element 131 is, for example, a complementary metal oxide semiconductor (CMOS) image sensor, or a charge coupled device (CCD) image sensor.

In accordance with the output image data, the processing unit 171 determines whether the foreign object FO is an adhering foreign object adhering to the IRCF 121. The processing unit 171 includes a processor, a memory, and a peripheral circuit. The memory stores a program. The processor executes the stored program, and operates the processor, the memory, and the peripheral circuit to serve as the processing unit 171. The processor is, for example, a central processing unit (CPU). The memory is, for example, a random access memory (RAM) or a read-only memory (ROM). The processing unit 171 may be partially, or entirely, formed of a dedicated electronic circuit.

### 1.2 Lens Fastening Mechanism

As illustrated in FIG. 1, the lens fastening mechanism 112 includes: a lens socket 201; and a placing table 202.

The lens 111 is inserted into the lens socket 201. The lens socket 201 holds the inserted lens 111. On the placing table 202, the lens socket 201 is placed.

### 1.3 IRCF Displacing Mechanism

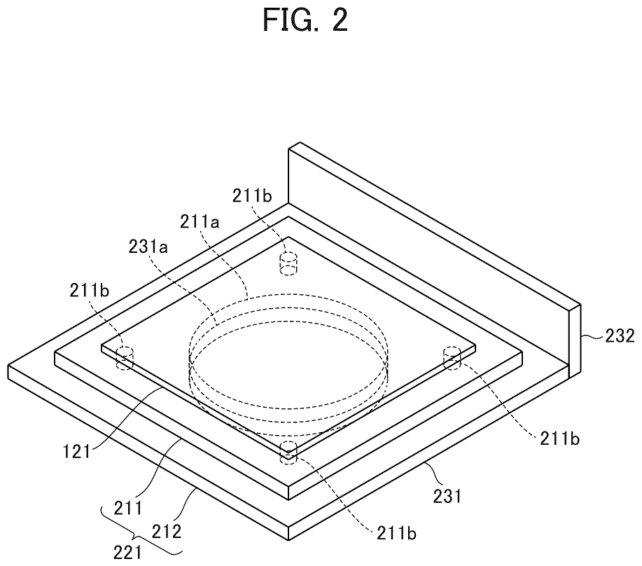

FIG. 2 is a perspective view schematically illustrating a support table and a placing table included in the inspection apparatus of the first embodiment, and the IRCF to be inspected with the inspection apparatus.

As illustrated in FIGS. 1 and 2, the IRCF displacing mechanism 123 includes: a support table 211; a placing table 212; and a pump 213.

The IRCF 121 is placed on the support table 211. The support table 211 is placed on the placing table 212. Hence, the support table 211 and the placing table 212 constitute a support mechanism 221 to support the IRCF 121.

The support table 211 sucks the IRCF 121 when the air is sucked, and stops sucking the IRCF 121 when the suction of the air stops. The pump 213 sucks the air from the support table 211 to allow the support table 211 to suck the IRCF 121, and stops sucking the air from the support table 211 to allow the support table 211 to stop sucking the IRCF 121. Hence, the support table 211 and the pump 213 constitute a suction mechanism 222 to switch between a state in which the IRCF 121 is sucked and a state in which the IRCF 121 is not sucked. The IRCF 121 is displaced when the suction mechanism 222 performs the switching. Thus, the IRCF displacing mechanism 123 performs the switching to displace the IRCF 121.

The support table 211 is shaped into a rectangular plate. The support table 211 includes: a hole 211a; and a hole 211b. The hole 211a serves as a travel path of the light L. The hole 211a serves as a suction path of the air. The pump 213 sucks the air through the hole 211b. The IRCF 121 is placed on the support table 211 so that a center portion of the IRCF 121 covers the hole 211a and a peripheral portion of the IRCF 121 covers the hole 211b.

The placing table 212 is shaped into an L-shaped plate. Hence, the placing table 212 includes: a horizontal plate 231; and a vertical plate 232. Each of the horizontal plate 231 and the vertical plate 232 is shaped into a rectangular plate. One side of the horizontal plate 231 and one side of the vertical plate 232 are connected together. The horizontal plate 231 includes a hole 231a. The hole 23 la serves as a travel path of the light L. The support table 211 is placed on the horizontal plate 231 so that the hole 23 la communicates with the hole 211a of the support table 211.

### 1.4 Sequence of Inspection

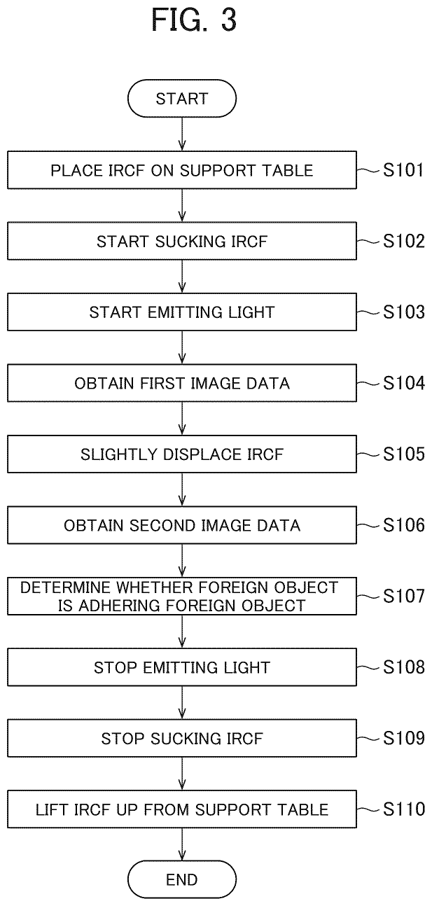

FIG. 3 is a flowchart showing a sequence of inspecting the IRCF with the inspection apparatus of the first embodiment.

When the IRCF 121 is inspected with the inspection apparatus 1, Steps S101 to S110 in FIG. 3 are carried out.

At Step S101, an automated conveyer mechanism or an operator places the IRCF 121 on the support table 211.

Subsequently, at Step S102, the processing unit 171 causes the suction mechanism 222 to start sucking the IRCF 121.

Subsequently, at Step S103, the processing unit 171 causes the light source 101 to start emitting the light L. Thus, an image including a shadow of the foreign object FO is formed on the imaging surface 131a of the imaging element 131.

Subsequently, at Step S104, the processing unit 171 causes the imaging element 131 to obtain the formed image. Thus, the processing unit 171 obtains first image data output from the imaging element 131.

Subsequently, at Step S105, the processing unit 171 causes the IRCF displacing mechanism 123 to slightly displace the IRCF 121.

Subsequently, at Step S106, the processing unit 171 causes the imaging element 131 to obtain the formed image. Thus, the processing unit 171 obtains second image data output from the imaging element 131.

Subsequently, at Step S107, the processing unit 171 determines whether the foreign object FO is an adhering foreign object adhering to the IRCF 121, in accordance with the first image data output before the IRCF displacing mechanism 123 displaces the IRCF 121 and with the second image data output after the IRCF displacing mechanism 123 displaces the IRCF 121.

Subsequently, at Step S108, the processing unit 171 causes the light source 101 to stop emitting the light L.

Subsequently, at Step S109, the processing unit 171 causes the suction mechanism 222 to stop sucking the IRCF 121.

Subsequently, at Step S110, the automated conveyer mechanism or the operator lifts the IRCF 121 up from the support table 211.

### 1.5 Determining Whether Foreign Object Is Adhering Foreign Object

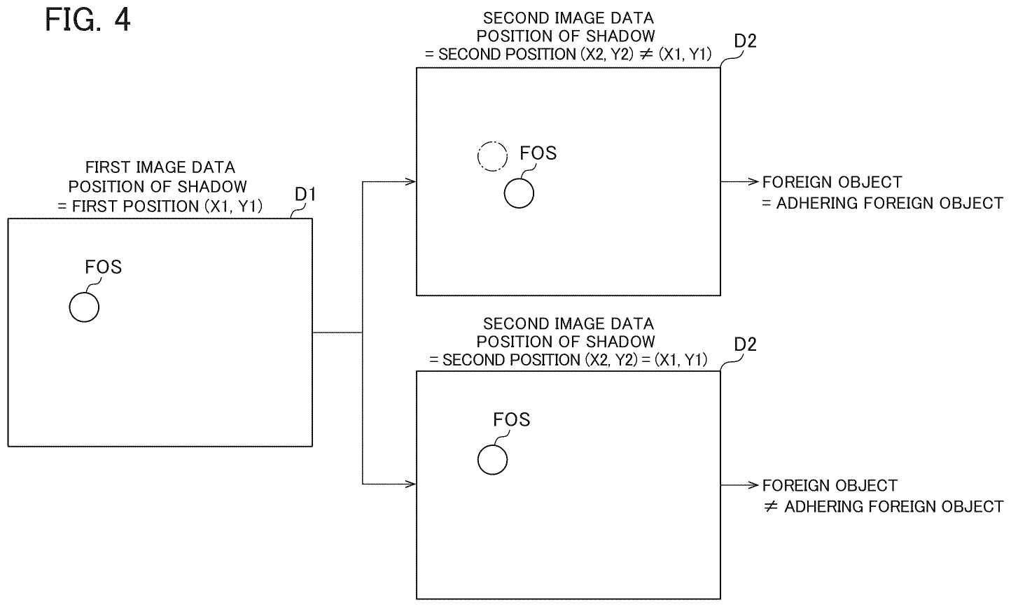

FIG. 4 is a diagram showing how a processing unit included in the inspection apparatus of the first embodiment determines whether a foreign object adhering to the IRCF is an adhering foreign object.

As illustrated in FIG. 4, when determining whether the foreign object FO is an adhering foreign object, the processing unit 171 identifies a first position (X1, Y1) and a second position (X2, Y2) of a shadow FOS respectively from first image data D1 and second image data D2.

If the foreign object FO is an adhering foreign object adhering to the IRCF 121, the shadow FOS is displaced as the IRCF 121 is displaced. Whereas, if the foreign object FO is not an adhering foreign object adhering to the IRCF 121, the shadow FOS is not displaced as the IRCF 121 is displaced. The processing unit 171 utilizes such a feature and determines whether the foreign object FO is an adhering foreign object adhering to the IRCF 121. That is, the processing unit 171 determines that the foreign object FO is an adhering foreign object if the second position (X2, Y2) is different from the first position (X1, Y1). Whereas, the processing unit 171 determines that the foreign object FO is not an adhering foreign object if the second position (X2, Y2) is equivalent to the first position (X1, Y1).

The processing unit 171 determines whether the foreign object FO is an adhering foreign object adhering to the IRCF 121 in accordance with the presence or absence of the displacement of the shadow FOS. If the presence of the adhering foreign object is suspected, such a feature can quickly determine whether the foreign object FO is an adhering foreign object without cleaning the IRCF 121 and re-inspecting the cleaned IRCF 121.

### 1.6 Producing Camera Module

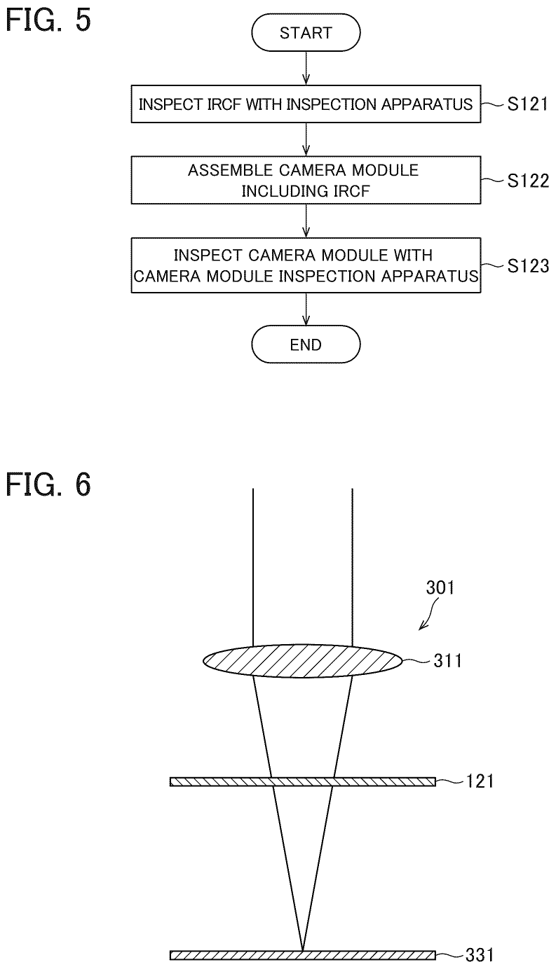

FIG. 5 is a flowchart showing a sequence of producing a camera module including the IRCF inspected with the inspection apparatus of the first embodiment.

In producing a camera module including the IRCF 121, Steps S121 to S123 in FIG. 5 are carried out.

At Step S121, the IRCF 121 is inspected with the inspection apparatus 1. Here, the processing unit 171 determines whether the foreign object FO is found in accordance with the image data output from the imaging element 131, and determines whether the found foreign object FO is an adhering foreign object adhering to the IRCF 121. Whether the foreign object FO is found is determined depending on whether the shadow FOS can be recognized.

Subsequently, at Step S122, a camera module including the IRCF 121 is assembled.

Subsequently, at Step S123, a camera module 301 is inspected with a camera module inspection apparatus.

### 1.7 Optical Alignment of Optical Members in Inspection Apparatus and in Camera Module

FIG. 6 is a cross-sectional view schematically illustrating optical alignment of a lens, an IRCF, and an imaging element included in the camera module. The IRCF is inspected with the inspection apparatus of the first embodiment.

As illustrated in FIG. 6, the camera module 301 to be produced includes: a lens 311 equivalent in kind to the lens 111 included in the inspection apparatus 1; the IRCF 121 inspected with the inspection apparatus 1; and an imaging element 331 equivalent in kind to the imaging element 131 included in the inspection apparatus 1.

As illustrated in FIGS. 1 and 6, the optical alignment of the lens 111, the IRCF 121, and the imaging element 131 in the inspection apparatus 1 is equivalent to the optical alignment of the lens 311, the IRCF 121, and the imaging element 331 included in the camera module 301. Hence, an optical path of a light ray transmitted through the lens 111 and the IRCF 121 and reaching the imaging element 131 in the inspection apparatus 1 matches an optical path of a light ray transmitted through the lens 311 and the IRCF 121 and reaching the imaging element 331 in the camera module 301. As can be seen, if the optical alignment of a first plurality of optical members included in the inspection apparatus 1 is equivalent to the alignment of a second plurality of optical members included in the camera module 301, the IRCF 121 to be inspected with the inspection apparatus 1 is under the same circumstance as a circumstance under which the IRCF 121 is in the camera module 301. Such a feature makes it possible to correlate optical characteristics of the first plurality of optical members in the inspection apparatus 1 with optical characteristics of the second plurality of optical members included in the camera module 301. This correlation makes it possible to appropriately inspect whether the foreign object FO adheres to the IRCF 121 to be used for the camera module 301. For example, this correlation makes it possible to avoid detecting an adhering foreign object that does not cause any problems to the camera module 301.

Note that, even if the optical alignment of the lens 111, the IRCF 121, and the imaging element 131 in the inspection apparatus 1 is not equivalent to the optical alignment of the lens 311, the IRCF 121, and the imaging element 331 included in the camera module 301, the inspection apparatus 1 can to some degree avoid detecting an adhering foreign object that does not cause any problems to the camera module 301.

### 1.8 Inspection Conditions of Inspection Apparatus and Camera Module Inspection Apparatus

An inspection condition of a camera module inspection apparatus is equivalent to the inspection condition of the inspection apparatus 1. Such a feature makes it possible to further avoid detecting an adhering foreign object that does not cause any problems to the camera module 301. The equivalent inspection conditions include the alignment of the light source, the luminance setting of the light source, and a test program to be used.

### 2 Second Embodiment

Described below will be how a second embodiment is different from the first embodiment. Otherwise, the same configurations as those employed in the first embodiment are also employed in the second embodiment.

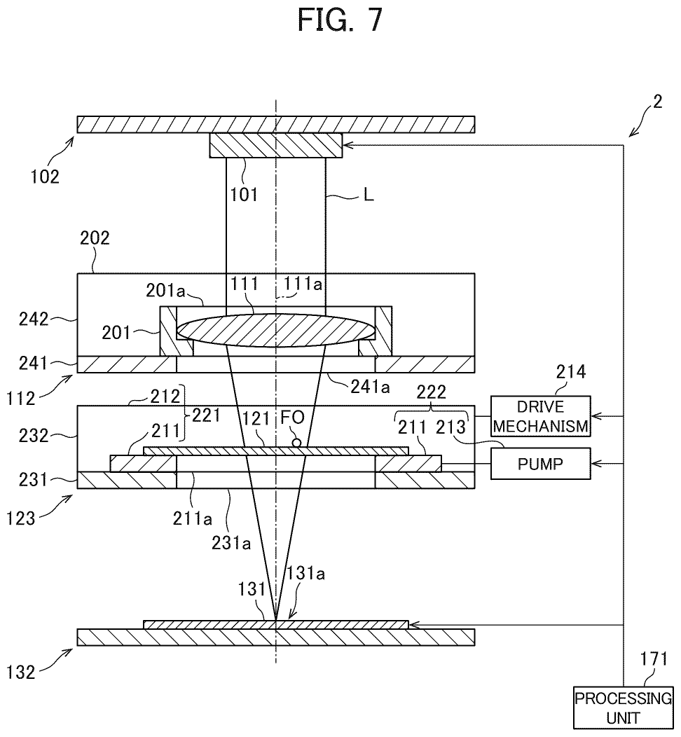

FIG. 7 is a diagram schematically illustrating an inspection apparatus of a second embodiment and an IRCF to be inspected with the inspection apparatus.

As to an inspection apparatus 2 of the second embodiment illustrated in FIG. 7, the IRCF displacing mechanism 123 further includes a drive mechanism 214.

The drive mechanism 214 displaces the support mechanism 221 in a direction perpendicular to the optical axis 111a of the lens 111, so as to displace the IRCF 121 in the direction. The drive mechanism 214 is an XY-axis robot. The XY-axis robot holds the vertical plate 232, and displaces the held vertical plate 232 either in an X-direction or in a Y-direction each perpendicular to the optical axis 111a of the lens 111. Hence, the XY-axis robot displaces the IRCF 121 either in the X-direction or in the Y-direction. The drive mechanism 214 may be a drive mechanism other than the XY-axis robot.

The drive mechanism 214 may displace the support mechanism 221 in a direction parallel to the optical axis 111a of the lens 111, so as to displace the IRCF 121 in the direction. In such a case, the drive mechanism 214 is a Z-axis robot. The Z-axis robot holds the vertical plate 232, and displaces the held vertical plate 232 in a Z-direction parallel to the optical axis 111a of the lens 111. Hence, the Z-axis robot displaces the IRCF 121 in the Z-direction. The drive mechanism 214 may be a drive mechanism other than the Z-axis robot.

If the drive mechanism 214 displaces the IRCF 121 in the Z-direction, the processing unit 171 identifies a first size and a second size of the shadow FOS respectively from the first image data D1 and the second image data D2. If the second size is different from the first size, the processing unit 171 may determine that the foreign object FO is an adhering foreign object adhering to the IRCF 121. If the second size is equivalent to the first size, the processing unit 171 may determine that the foreign object FO is not an adhering foreign object adhering to the IRCF 121.

### 3 Third Embodiment

Described below will be how a third embodiment is different from the first embodiment. Otherwise, the same configurations as those employed in the first embodiment are also employed in the third embodiment.

### 3.1 Inspection Apparatus

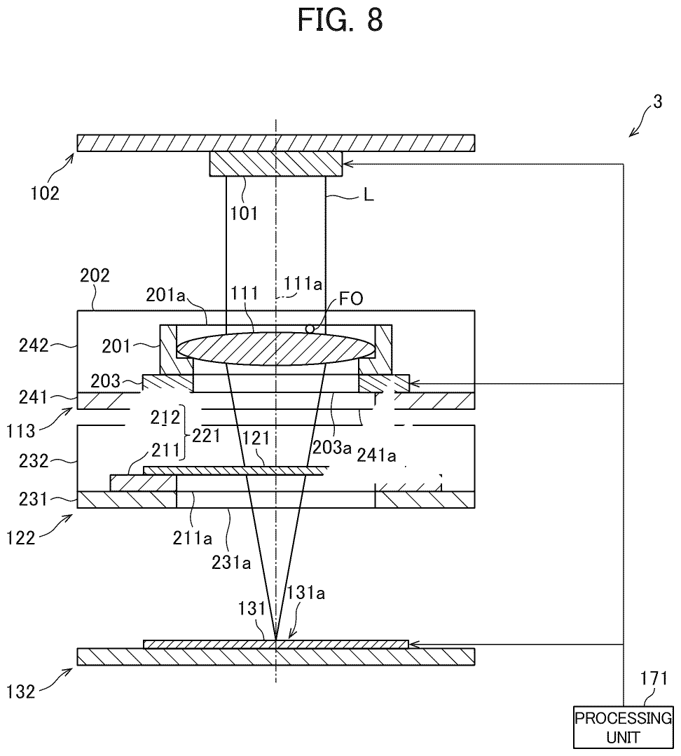

FIG. 8 is a diagram schematically illustrating an inspection apparatus of a third embodiment and a lens to be inspected with the inspection apparatus.

An inspection apparatus 3 of the third embodiment illustrated in FIG. 8 is used for inspecting the lens 111. Inspecting the lens 111 also includes determining whether the foreign object FO adheres to the lens 111.

The lens 111 is an example of an optical member to be inspected with the inspection apparatus 3.

As illustrated in FIG. 8, the inspection apparatus 3 includes: the light source 101; the light source fastening mechanism 102; a lens displacing mechanism 113; the IRCF 121; an IRCF fastening mechanism 122; the imaging element 131; the imaging element fastening mechanism 132; and the processing unit 171.

The light source 101, the IRCF 121, and the imaging element 131 are respectively fastened to the light source fastening mechanism 102, the IRCF fastening mechanism 122, and the imaging element fastening mechanism 132. The lens 111 is attached to, and detached from, the lens displacing mechanism 113 by an operator or with an automated conveyer mechanism.

When the lens 111 is inspected with the inspection apparatus 3, the lens 111 is attached to the lens displacing mechanism 113. In a state where the lens 111 is attached to the lens displacing mechanism 113, the light source 101, the lens 111, the IRCF 121, and the imaging element 131 are aligned in the stated order along the optical axis 111a of the lens 111. The lens 111 and the IRCF 121 are disposed between the light source 101 and the imaging element 131.

In accordance with image data output by the imaging element 131, the processing unit 171 determines whether the foreign object FO is an adhering foreign object adhering to the lens 111.

### 3.2 Lens Displacing Mechanism

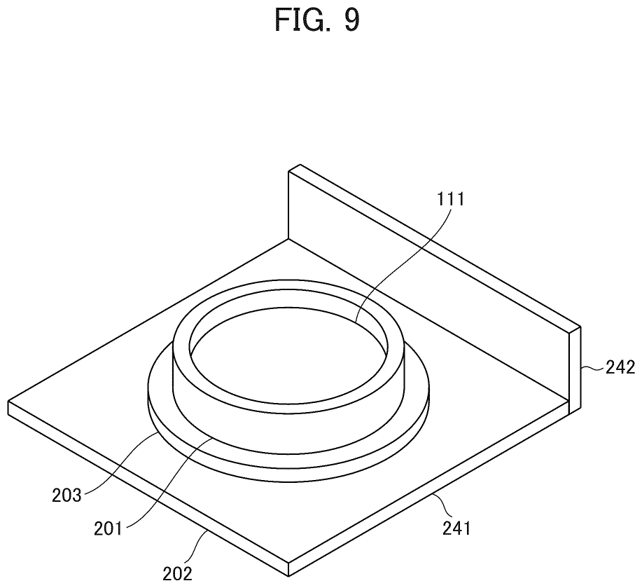

FIG. 9 is a perspective view schematically illustrating a lens socket, a rotary stage, and a rotary stage placing table included in the inspection apparatus of the third embodiment, and a lens to be inspected with the inspection apparatus.

As illustrated in FIGS. 8 and 9, the lens displacing mechanism 113 includes: the lens socket 201; the placing table 202; and a rotary stage 203.

The lens 111 is inserted into the lens socket 201. The lens socket 201 holds the inserted lens 111. On the rotary stage 203, the lens socket 201 is placed. The rotary stage 203 rotates the placed lens socket 201 about the optical axis 111a of the lens 111 so as to displace the lens 111. The rotary stage 203 may be replaced with a drive mechanism other than the rotary stage 203. On the placing table 202, the rotary stage 203 is placed.

The lens displacing mechanism 113 may include a suction mechanism that switches between a state in which the lens 111 is sucked and a state in which the lens 111 is not sucked. Through the switching, the lens displacing mechanism 113 may displace the lens 111. The lens displacing mechanism 113 may alternatively include a drive mechanism that displaces a support mechanism supporting the lens 111 in a direction perpendicular to, or parallel to, the optical axis 111a of the lens 111 so as to displace the lens 111 in the direction.

The lens socket 201 is shaped into a cylindrical shape. The lens socket 201 includes a housing hole 201a. The housing hole 201a houses the lens 111, and serves as a travel path of the light L.

The rotary stage 203 is shaped into a cylindrical shape. The rotary stage 203 includes a hole 203a. The hole 203a serves as a travel path of the light L. The lens socket 201 is placed on the rotary stage 203 so that the hole 203a communicates with the housing hole 201a of the lens socket 201.

The placing table 202 is shaped into an L-shaped plate. Hence, the placing table 202 includes: a horizontal plate 241; and a vertical plate 242. Each of the horizontal plate 241 and the vertical plate 242 is shaped into a rectangular plate. One side of the horizontal plate 241 and one side of the vertical plate 242 are connected together. The horizontal plate 241 includes a hole 241a. The hole 241a serves as a travel path of the light L. The rotary stage 203 is placed on the horizontal plate 241 so that the hole 241a communicates with the hole 203a of the rotary stage 203.

### 1.1 Sequence of Inspection

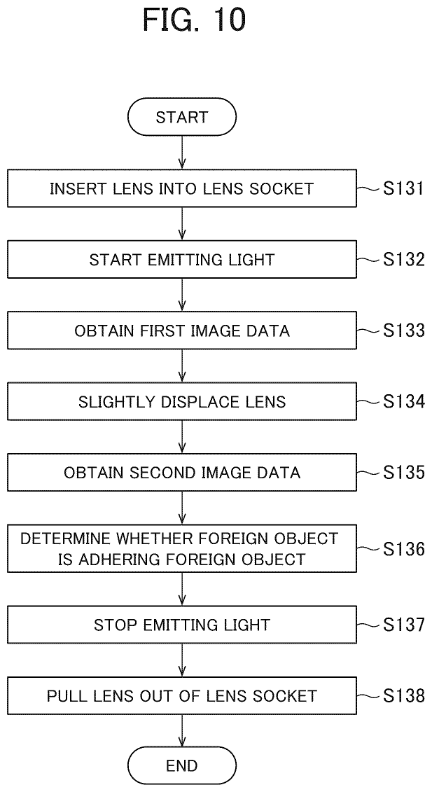

FIG. 10 is a flowchart showing a sequence of inspecting the lens with the inspection apparatus of the third embodiment.

When the lens 111 is inspected with the inspection apparatus 3, Steps S131 to S138 in FIG. 10 are carried out.

At Step S131, an automated conveyer mechanism or an operator inserts the lens 111 into the lens socket 201.

Subsequently, at Step S132, the processing unit 171 causes the light source 101 to start emitting the light L. Thus, an image including a shadow of the foreign object FO is formed on the imaging surface 13 la of the imaging element 131.

Subsequently, at Step S133, the processing unit 171 causes the imaging element 131 to obtain the formed image. Thus, the processing unit 171 obtains the first image data D1 output from the imaging element 131.

Subsequently, at Step S134, the processing unit 171 causes the lens displacing mechanism 113 to slightly displace the lens 111.

Subsequently, at Step S135, the processing unit 171 causes the imaging element 131 to obtain the formed image. Thus, the processing unit 171 obtains the second image data D2 output from the imaging element 131.

Subsequently, at Step S136, the processing unit 171 determines whether the foreign object FO is an adhering foreign object adhering to the lens 111, in accordance with the first image data D1 output before the lens displacing mechanism 113 displaces the lens 111 and with the second image data D2 output after the lens displacing mechanism 113 displaces the lens 111. When determining whether the foreign object FO is an adhering foreign object, the processing unit 171 identifies the first position (X1, Y1) and the second position (X2, Y2) of the shadow FOS respectively from first image data D1 and second image data D2. The processing unit 171 determines that the foreign object FO is an adhering foreign object adhering to the lens 111 if the second position (X2, Y2) is different from the first position (X1, Y1). Whereas, the processing unit 171 determines that the foreign object FO is not an adhering foreign object adhering to the lens 111 if the second position (X2, Y2) is equivalent to the first position (X1, Y1).

Subsequently, at Step S137, the processing unit 171 causes the light source 101 to stop emitting the light L.

Subsequently, at Step S138, the automated conveyer mechanism or the operator pulls the lens 111 out of the lens socket 201.

### 1.2 Producing Camera Module

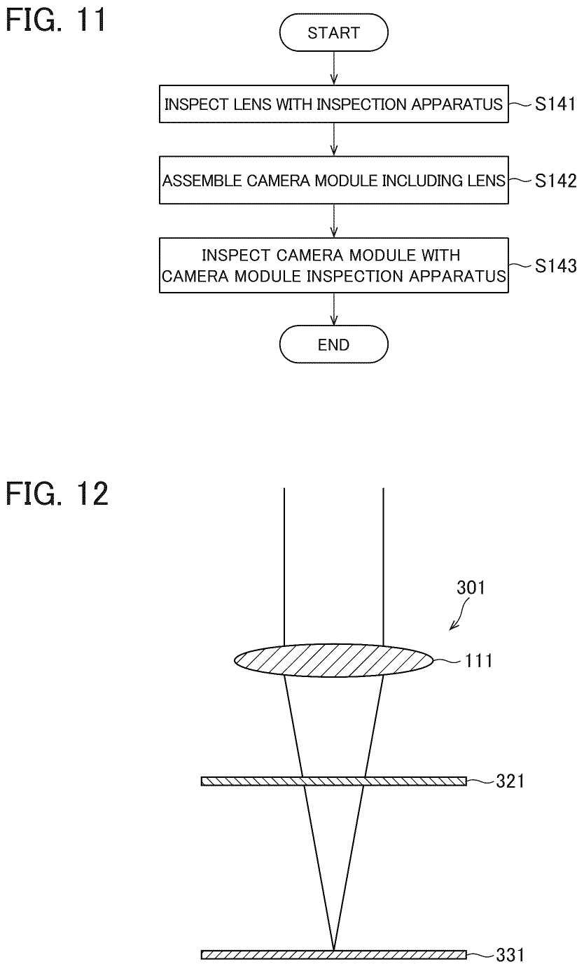

FIG. 11 is a flowchart showing a sequence of producing a camera module including the lens inspected with the inspection apparatus of the third embodiment.

In producing a camera module including the lens 111, Steps S141 to S143 in FIG. 11 are carried out.

At Step S141, the lens 111 is inspected with the inspection apparatus 3. Here, the processing unit 171 determines whether the foreign object FO is found in accordance with the image data output from the imaging element 131, and determines whether the found foreign object FO is an adhering foreign object adhering to the lens 111.

Subsequently, at Step S142, a camera module including the lens 111 is assembled.

Subsequently, at Step S143, the camera module 301 is inspected with the camera module inspection apparatus.

### 1.3 Optical Alignment of Optical Members in Inspection Apparatus and in Camera Module

FIG. 12 is a cross-sectional view schematically illustrating optical alignment of a lens, an IRCF, and an imaging element included in a camera module, the lens being inspected with the inspection apparatus of the third embodiment.

As illustrated in FIG. 12, the camera module 301 to be produced includes: the lens 111 inspected with the inspection apparatus 3; an IRCF 321 equivalent in kind to the IRCF 121 included in the inspection apparatus 3; and an imaging element 331 equivalent in kind to the imaging element 131 included in the inspection apparatus 3.

As illustrated in FIGS. 8 and 12, the optical alignment of the lens 111, the IRCF 121, and the imaging element 131 in the inspection apparatus 3 is equivalent to the optical alignment of the lens 111, the IRCF 321, and the imaging element 331 included in the camera module 301. Hence, an optical path of a light ray transmitted through the lens 111 and the IRCF 121 and reaching the imaging element 131 in the inspection apparatus 3 matches an optical path of a light ray transmitted through the lens 111 and the IRCF 321 and reaching the imaging element 331 in the camera module 301. As can be seen, if the optical alignment of a first plurality of optical members included in the inspection apparatus 3 is equivalent to the alignment of a second plurality of optical members included in the camera module 301, the lens 111 to be inspected with the inspection apparatus 3 is under the same circumstance as a circumstance under which the lens 111 is in the camera module 301. Such a feature makes it possible to correlate optical characteristics of the first plurality of optical members in the inspection apparatus 3 with optical characteristics of the second plurality of optical members included in the camera module 301. This correlation makes it possible to appropriately inspect whether the foreign object FO adheres to the lens 111 to be used for the camera module 301. For example, this correlation makes it possible to, to some degree, avoid detecting an adhering foreign object that does not cause any problems to the camera module 301.

Note that, even if the optical alignment of the lens 111, the IRCF 121, and the imaging element 131 in the inspection apparatus 3 is not equivalent to the optical alignment of the lens 111, the IRCF 321, and the imaging element 331 included in the camera module 301, the inspection apparatus 3 can avoid detecting an adhering foreign object that does not cause any problems to the camera module 301.

### 1.4 Inspection Conditions of Inspection Apparatus and Camera Module Inspection Apparatus

An inspection condition of a camera module inspection apparatus is equivalent to the inspection condition of the inspection apparatus 3. Such a feature makes it possible to further avoid detecting an adhering foreign object that does not cause any problems to the camera module 301. The equivalent inspection conditions include the alignment of the light source, the luminance setting of the light source, and a test program to be used.

### 2 Fourth Embodiment

Described below will be how a fourth embodiment is different from the first embodiment. Otherwise, the same configurations as those employed in the first embodiment are also employed in the fourth embodiment.

### 2.1 Inspection Apparatus

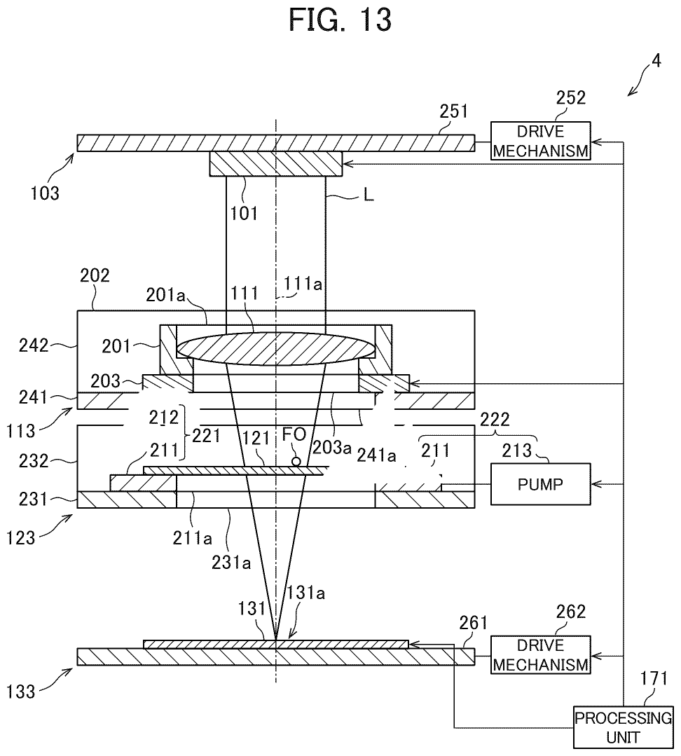

FIG. 13 is a diagram schematically illustrating an inspection apparatus of a fourth embodiment and an IRCF to be inspected with the inspection apparatus.

An inspection apparatus 4 of the fourth embodiment illustrated in FIG. 13 is used for inspecting the IRCF 121.

As illustrated in FIG. 13, the inspection apparatus 4 includes: the light source 101; a light source displacing mechanism 103; the lens 111; the lens displacing mechanism 113; the IRCF displacing mechanism 123; the imaging element 131; an imaging element displacing mechanism 133; and the processing unit 171.

The light source 101, the lens 111, the IRCF 121, and the imaging element 131 are respectively attached to, and detached from, the light source displacing mechanism 103, the lens displacing mechanism 113, the IRCF displacing mechanism 123, and the imaging element displacing mechanism 133 by an operator or with an automated conveyer mechanism.

As to the inspection apparatus 4, the IRCF 121 is a first optical member to be inspected, and the light source 101, the lens 111, and the imaging element 131 are second optical members not to be inspected. Furthermore, the IRCF displacing mechanism 123 is a first displacing mechanism to displace the first optical member to be inspected. The light source displacing mechanism 103, the lens displacing mechanism 113, and the imaging element displacing mechanism 133 are second displacing mechanisms to displace the second optical members not to be inspected. The lens 111 may be the first optical member to be inspected, and the light source 101, the IRCF 121, and the imaging element 131 may be the second optical members not to be inspected. Furthermore, the lens displacing mechanism 113 may be the first displacing mechanism to displace the first optical member to be inspected. The light source displacing mechanism 103, the IRCF displacing mechanism 123, and the imaging element displacing mechanism 133 may be the second displacing mechanisms to displace the second optical members not to be inspected.

If the IRCF 121 is inspected with the inspection apparatus 4, the light source 101, the lens 111, the IRCF 121, and the imaging element 131 are respectively attached to the light source displacing mechanism 103, the lens displacing mechanism 113, the IRCF displacing mechanism 123, and the imaging element displacing mechanism 133. In a state where the light source 101, the lens 111, the IRCF 121, and the imaging element 131 are respectively attached to the light source displacing mechanism 103, the lens displacing mechanism 113, the IRCF displacing mechanism 123, and the imaging element displacing mechanism 133, the light source 101, the lens 111, the IRCF 121, and the imaging element 131 are aligned in the stated order along the optical axis 111a of the lens 111. The lens 111 and the IRCF 121 are disposed between the light source 101 and the imaging element 131.

As illustrated in FIG. 13, the light source displacing mechanism 103 includes: a support mechanism 251; and a drive mechanism 252. The support mechanism 251 supports the light source 101. The drive mechanism 252 displaces the support mechanism 251 to displace the light source 101.

The lens displacing mechanism 113 is equivalent to the lens displacing mechanism 113 included in the inspection apparatus 3 of the third embodiment.

As illustrated in FIG. 13, the imaging element displacing mechanism 133 includes: a support mechanism 261; and a drive mechanism 262. The support mechanism 261 supports the imaging element 131. The drive mechanism 262 displaces the support mechanism 261 to displace the imaging element 131.

### 2.2 Sequence of Inspection

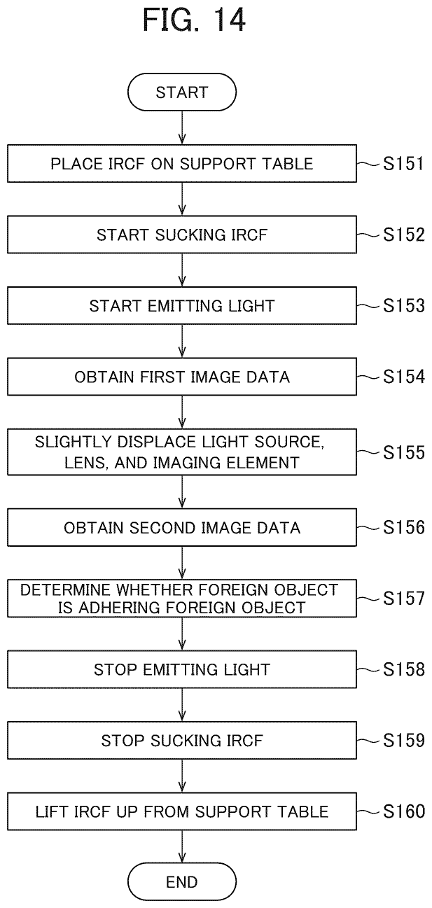

FIG. 14 is a flowchart showing a sequence of inspecting the IRCF with the inspection apparatus of the fourth embodiment.

When the IRCF 121 is inspected with the inspection apparatus 4, Steps S151 to S160 in FIG. 14 are carried out.

Steps S151 to S153 involve the same processing as the processing carried out at Steps S111 to S113 shown in FIG. 3.

Subsequently, at Step S154, the processing unit 171 causes the imaging element 131 to obtain the formed image. Thus, the processing unit 171 obtains the first image data D1 output from the imaging element 131.

Subsequently, at Step S155, the processing unit 171 causes the light source displacing mechanism 103, the lens displacing mechanism 113, and the imaging element displacing mechanism 133 to respectively and slightly displace the light source 101, the lens 111, and the imaging element 131.

Subsequently, at Step S156, the processing unit 171 causes the imaging element 131 to obtain the formed image. Thus, the processing unit 171 obtains the second image data D2 output from the imaging element 131.

Subsequently, at Step S157, the processing unit 171 determines whether the foreign object FO is an adhering foreign object adhering to the IRCF 121, in accordance with the first image data D1 output before the light source displacing mechanism 103, the lens displacing mechanism 113, and the imaging element displacing mechanism 133 respectively displace the light source 101, the lens 111, and the imaging element 131 and with the second image data D2 output after the light source displacing mechanism 103, the lens displacing mechanism 113, and the imaging element displacing mechanism 133 respectively displace the light source 101, the lens 111, and the imaging element 131.

Subsequently, Steps S158 to S160 involve the same processing as the processing carried out at Steps S118 to S120 shown in FIG. 3.

### 2.3 Determining Whether Foreign Object Is Adhering Foreign Object

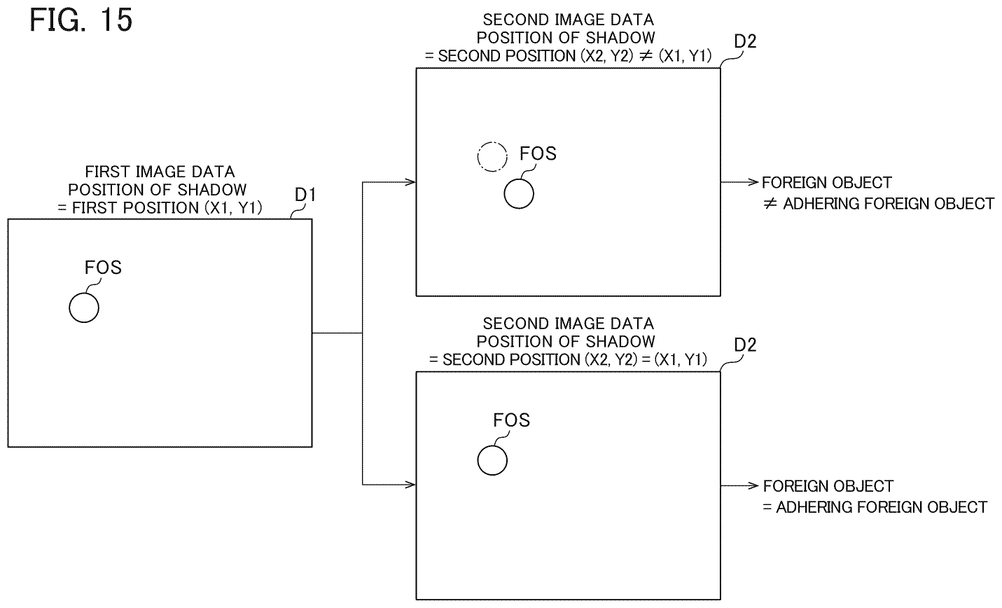

FIG. 15 is a diagram showing how a processing unit included in the inspection apparatus of the fourth embodiment determines whether a foreign object adhering to an IRCF lens is an adhering foreign object.

As to the inspection apparatus 4, when determining whether the foreign object FO is an adhering foreign object as illustrated in FIG. 15, the processing unit 171 identifies the first position (X1, Y1) and the second position (X2, Y2) of the shadow FOS respectively from the first image data D1 and the second image data D2.

If the foreign object FO is an adhering foreign object adhering to the IRCF 121, the shadow FOS is not displaced as the light source 101, the lens 111, and the imaging element 131 are displaced. Whereas, if the foreign object FO is not an adhering foreign object adhering to the IRCF 121; that is, if the foreign object FO is a foreign object adhering to the light source 101, the lens 111, or the imaging element 131, the shadow FOS is displaced as the IRCF 121 is displaced. The processing unit 171 utilizes such a feature and determines whether the foreign object FO is an adhering foreign object adhering to the IRCF 121. That is, the processing unit 171 determines that the foreign object FO is not an adhering foreign object if the second position (X2, Y2) is different from the first position (X1, Y1). Whereas, the processing unit 171 determines that the foreign object FO is an adhering foreign object if the second position (X2, Y2) is equivalent to the first position (X1, Y1).

### 3 Fifth Embodiment

Described below will be how a fifth embodiment is different from the first embodiment. Otherwise, the same configurations as those employed in the first embodiment are also employed in the fifth embodiment.

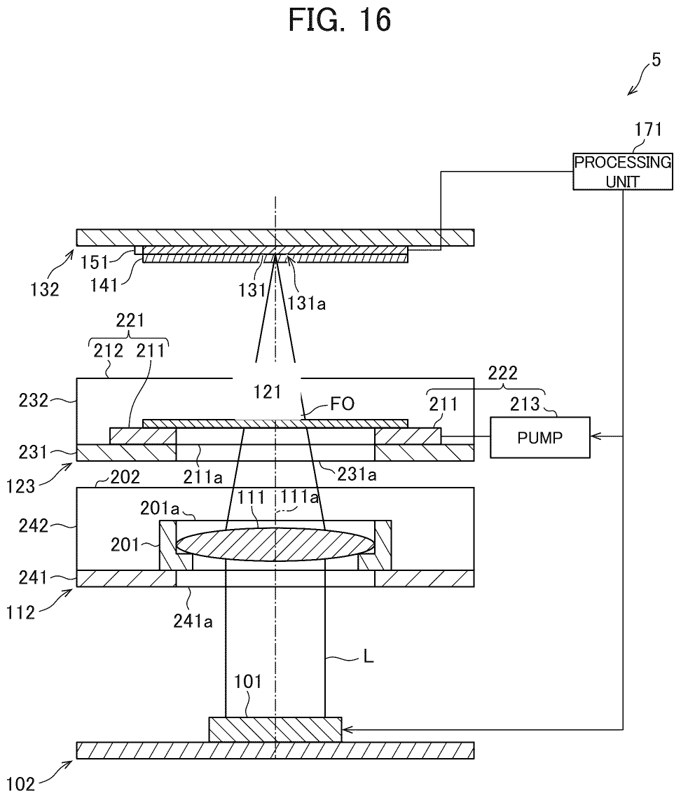

FIG. 16 is a diagram schematically illustrating an inspection apparatus of a fifth embodiment and an IRCF to be inspected with the inspection apparatus.

As to an inspection apparatus 5 of the fifth embodiment illustrated in FIG. 16, the imaging element 131 has an imaging surface 131a facing vertically downward. Such a feature makes it possible to keep a foreign object from adhering to the imaging surface 131a. As a result, the inspection apparatus 5 can inspect more accurately whether the foreign object FO adheres to the IRCF 121.

Moreover, the inspection apparatus 5 further includes a cooling mechanism 151.

The cooling mechanism 151 cools the imaging element 131. Such a feature makes it possible to keep, for example, sebum of a human body from adhering to the imaging element 131. As a result, the inspection apparatus 5 can inspect more accurately whether the foreign object FO adheres to the IRCF 121. The cooling mechanism 151 is, for example, a Peltier element.

Moreover, the inspection apparatus 5 further includes a glass cover 141. The glass cover 141 covers the imaging surface 131a of the imaging element 131.

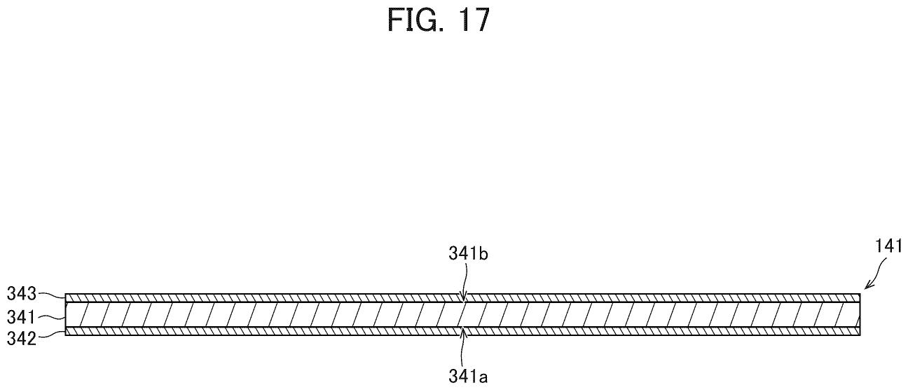

FIG. 17 is a cross-sectional view schematically illustrating a glass cover included in the inspection apparatus of the fifth embodiment.

As illustrated in FIG. 17, the glass cover 141 includes: a glass plate 341; a first coat 342; and a second coat 343. One of the first coat 342 or the second coat 343 may be omitted.

The glass plate 341 has a first main surface 341a and a second main surface 341b. The first main surface 341a and the second main surface 341b are across from each other.

The first coat 342 is formed on, and covers, the first main surface 341a. The second coat 343 is formed on, and covers, the second main surface 341b. The first coat 342 and the second coat 343 are made of a material that is less likely to catch a foreign object. For example, the first coat 342 and the second coat 343 are made of fluorine resin. Such a feature makes it possible to keep a foreign object from adhering to the imaging surface 131a of the imaging element 131. As a result, the inspection apparatus 5 can inspect more accurately whether the foreign object FO adheres to the IRCF 121.

### 4 Sixth Embodiment

Described below will be how a sixth embodiment is different from the first embodiment. Otherwise, the same configurations as those employed in the first embodiment are also employed in the sixth embodiment.

### 4.1 Inspection Apparatus

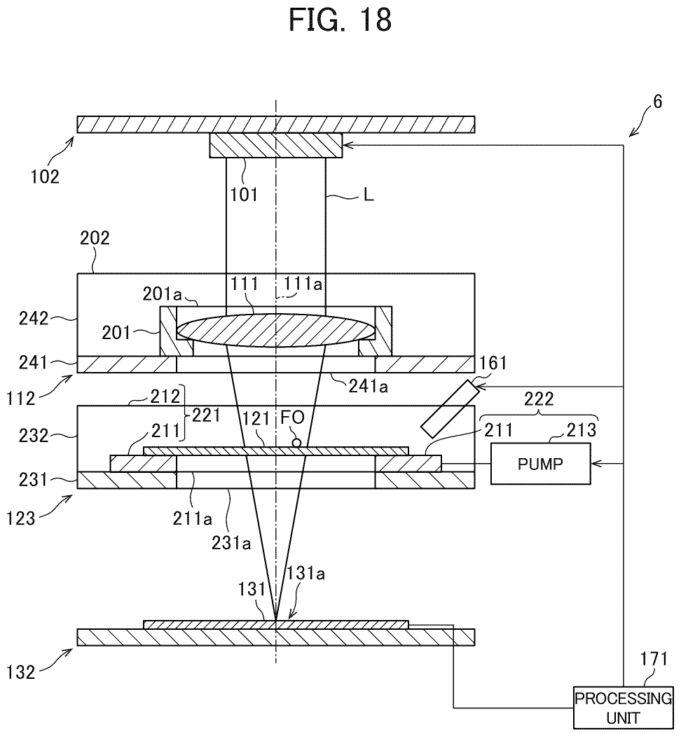

FIG. 18 is a diagram schematically illustrating an inspection apparatus of the sixth embodiment and an IRCF to be inspected with the inspection apparatus.

An inspection apparatus 6 of the sixth embodiment illustrated in FIG. 18 further includes a removing mechanism 161.

The removing mechanism 161 removes an adhering foreign object adhering to the IRCF 121. The removing mechanism 161 is, for example, a blower that blows an air flow to the IRCF 121, or an ionizer blower that blows an air flow containing ions to the IRCF 121.

### 4.2 Sequence of Inspection

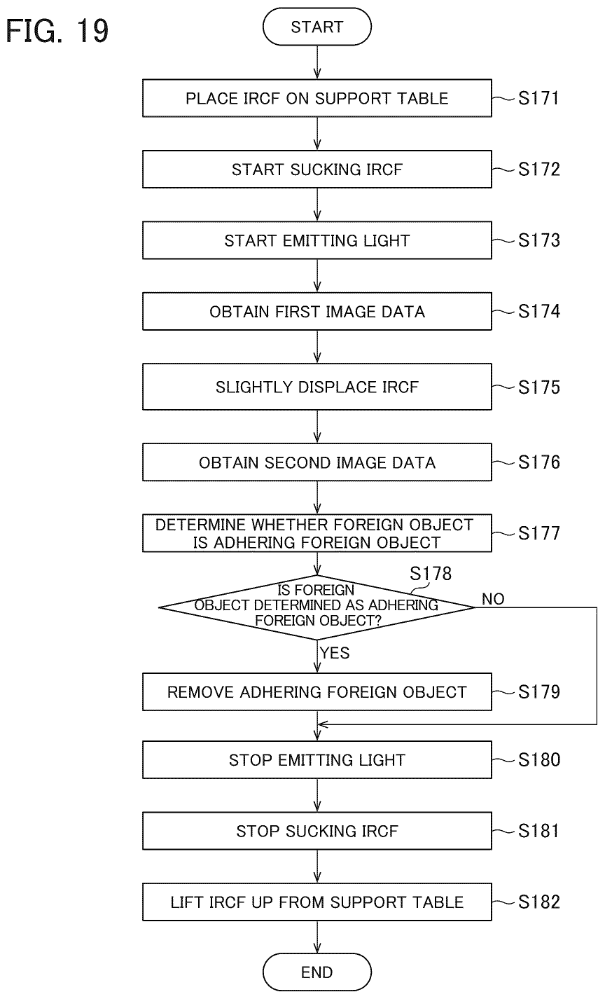

FIG. 19 is a flowchart showing a sequence of inspecting the IRCF with the inspection apparatus of the sixth embodiment.

When the IRCF 121 is inspected with the inspection apparatus 6, Steps S171 to S182 in FIG. 19 are carried out.

Steps S171 to S177 involve the same processing as the processing carried out at Steps S101 to S107 shown in FIG. 3.

Subsequently, at Step S178, the processing unit 171 changes the succeeding processing, depending on whether the foreign object FO is determined as an adhering foreign object. If the processing unit 171 determines that the foreign object FO is an adhering foreign object, the processing unit 171 carries out Step S179 and then Step S180. If the processing unit 171 determines that the foreign object FO is not an adhering foreign object, the processing unit 171 omits Step S179 and carries out Step S180.

At Step S179, the processing unit 171 causes the removing mechanism 161 to remove the adhering foreign object adhering to the IRCF 121. As a result, even if the foreign object FO adheres to the IRCF 121, the IRCF 121 finally obtained has no foreign object FO adhering thereto.

Steps S180 to S182 involve the same processing as the processing carried out at Steps S108 to S110 shown in FIG. 3.

The present disclosure shall not be limited to the above-described embodiments, and may be replaced with a configuration substantially the same as, a configuration having the same advantageous effects as, or a configuration capable of achieving the same object as, the configurations described in the above-described embodiments.

What is claimed is:

1. An inspection apparatus, comprising:
an attaching-detaching unit configured to attach and detach an optical member to be used for a camera module;
a light source configured to emit light to be transmitted through the optical member; and
an imaging element configured to obtain an image formed of the light transmitted through the optical member, the image including a shadow of a foreign object.

2. The inspection apparatus according to claim 1,
wherein the shadow is a defocused image.

3. The inspection apparatus according to claim 1,
wherein the imaging element outputs image data corresponding to the image, and
the inspection apparatus further comprises a processing unit configured to determine, in accordance with the image data, whether the foreign object is an adhering foreign object adhering to the optical member.

4. The inspection apparatus according to claim 3, further comprising
a displacing mechanism configured to displace the optical member,
wherein the determining, in accordance with the image data, whether the foreign object is the adhering foreign object includes: causing the displacing mechanism to displace the optical member; and determining whether the foreign object is the adhering foreign object, in accordance with first image data output by the imaging element before the displacing mechanism displaces the optical member and with second image data output by the imaging element after the displacing mechanism displaces the optical member.

5. The inspection apparatus according to claim 4,
wherein the determining, in accordance with the first image data and the second image data, whether the foreign object is the adhering foreign object includes: identifying a first position and a second position of the shadow respectively from the first image data and the second image data; determining that the foreign object is the adhering foreign object if the second position is different from the first position; and determining that the foreign object is not the adhering foreign object if the second position is equivalent to the first position.

6. The inspection apparatus according to claim 4,
wherein the displacing mechanism includes a suction mechanism configured to switch between a state in which the optical member is sucked and a state in which the optical member is not sucked, so as to displace the optical member.

7. The inspection apparatus according to claim 4, further comprising
a lens that transmits the light and has an optical axis,
wherein the displacing mechanism includes: a support mechanism configured to support the optical member; and a drive mechanism configured to displace the support mechanism either in a direction perpendicular to the optical axis or in a direction parallel to the optical axis so as to displace the optical member.

8. The inspection apparatus according to claim 4,
wherein the optical member is a lens that has an optical axis, and
the displacing mechanism includes: a lens socket configured to hold the lens; and a drive mechanism configured to rotate the lens socket about the optical axis so as to displace the optical member.

9. The inspection apparatus according to claim 3,
wherein the optical member is a first optical member,
the inspection apparatus further comprises: a second optical member; and a displacing mechanism configured to displace the second optical member, and
the determining, in accordance with the image data, whether the foreign object is the adhering foreign object includes: causing the displacing mechanism to displace the second optical member; and determining whether the foreign object is the adhering foreign object, in accordance with first image data output by the imaging element before the displacing mechanism displaces the second optical member and with second image data output by the imaging element after the displacing mechanism displaces the second optical member.

10. The inspection apparatus according to claim 9,
wherein the determining, in accordance with the first image data and the second image data, whether the foreign object is the adhering foreign object includes: identifying a first position and a second position of the shadow respectively from the first image data and the second image data; determining that the foreign object is not the adhering foreign object if the first position is different from the second position; and determining that the foreign object is the adhering foreign object if the first position is equivalent to the second position.

11. The inspection apparatus according to claim 3, further comprising
a removing mechanism configured to remove the adhering foreign object,
wherein, if the processing unit determines that the foreign object is the adhering foreign object, the processing unit causes the removing mechanism to remove the adhering foreign object.

12. The inspection apparatus according to claim 1,
wherein the imaging element has an imaging surface on which the image is formed, and
the imaging surface faces vertically downward.

13. The inspection apparatus according to claim 1,
wherein the imaging element has an imaging surface on which the image is formed, and
the inspection apparatus further comprises a glass cover including: a glass plate having a main surface; and a coat formed on the main surface, the glass cover covering the imaging surface.

14. The inspection apparatus according to claim 1, further comprising
a cooling mechanism configured to cool the imaging element.

15. The inspection apparatus according to claim 1,
wherein the optical member is either an infrared cut filter or a lens.

16. A method for producing a camera module, the method comprising steps of:
a) inspecting the optical member using the inspection apparatus according to claim 1, while optical alignment of a first plurality of optical members including the optical member in the inspection apparatus is set equivalent to optical alignment of a second plurality of optical members including the optical member in the camera module; and
b) assembling the camera module after step a).

17. A method for producing a camera module, the method comprising steps of:
a) inspecting the optical member with the inspection apparatus according to claim 1;
b) assembling the camera module after step a); and
c) inspecting the camera module after step b) using a camera module inspection apparatus, while an inspection condition of the camera module inspection apparatus is set equivalent to an inspection condition of the inspection apparatus.
